(19) United States
(12) Patent Application Publication
(10) Pub. No.: US 2018/0149854 A1
(43) Pub. Date: May 31, 2018

(54) Light Sheet Microscopy Arrangement and Method

(71) Applicant: Carl Zeiss Microscopy GmbH, Jena (DE)

(72) Inventors: Jörg Siebenmorgen, Jena (DE); Helmut LIPPERT, Jena (DE); Thomas KALKBRENNER, Jena (DE); Ingo Kleppe, Jena (DE); Ralf Wolleschensky, Jena (DE)

(73) Assignee: Carl Zeiss Microscopy GmbH, Jena (DE)

(21) Appl. No.: 15/577,527

(22) PCT Filed: May 25, 2016
(86) PCT No.: PCT/EP2016/061742

§ 371 Date: Nov. 28, 2017

(30) Foreign Application Priority Data
May 28, 2015 (DE) 102015209756.0

(51) Int. Cl. G02B 21/24; G02B 21/16; G02B 21/36; G06T 7/00; G02B 21/08; G06T 7/571

(52) U.S. Cl. CPC G02B 21/245; G02B 21/16; G02B 21/361; G06T 2207/10064; G02B 21/082; G06T 7/571; G06T 7/97

(57) ABSTRACT

An arrangement and method for light sheet microscopy. The arrangement has an illumination apparatus for producing a light sheet for illuminating a stripe of a specimen, and has a detection apparatus for detecting fluorescence radiation emitted by the specimen. The recording speed of the arrangement is increased by an illumination apparatus which is configured to produce at least one further light sheet that is arranged parallel to a first light sheet for illuminating a further stripe of the specimen, and advantageously by a detection apparatus which is configured for the simultaneous detection of the fluorescence radiation excited by the light sheets that are arranged parallel to one another.

The present application claims priority from International Patent Application No. PCT/EP2016/061742 filed on May 25, 2016, which claims priority from German Patent Application No. 10 2015 209 756.0 filed on May 28, 2015, the disclosures of which are incorporated herein by reference in their entirety.

### FIELD OF THE INVENTION

It is noted that citation or identification of any document in this application is not an admission that such document is available as prior art to the present invention.

The present invention relates to an arrangement for light sheet microscopy having a specimen plane, having an illumination apparatus which contains a light source and an illumination optical unit for producing a light sheet for illuminating a stripe of a specimen and for exciting fluorescence radiation, and having a detection apparatus which contains a sensor having a detection plane for detecting the fluorescence radiation, an imaging optical unit for imaging the fluorescence radiation emitted by the specimen on the sensor, and a detection axis perpendicular to the light sheet. Furthermore, the present invention relates to a corresponding method for light sheet microscopy.

A microscope in which the illumination beam path and the detection beam path are arranged substantially perpendicular to one another and by means of which the specimen is illuminated with a light sheet in the focal plane of the imaging objective or detection objective, i.e. perpendicular to the optical axis thereof, is designed for examining specimens according to the selective plane illumination microscopy (SPIM) method, i.e. light sheet microscopy. As a result of the illumination with a light sheet, fluorescence radiation is produced in the stripe of the specimen illuminated by the light sheet. For this purpose, the specimen additionally may contain dyes that are suitable for fluorescence. In contrast to confocal laser scanning microscopy (LSM), in which a three-dimensional specimen is scanned point-by-point in individual planes at different depths and the image information obtained in the process is subsequently combined to form a three-dimensional image of the specimen, the SPIM technology is based on the wide-field microscopy and facilitates the pictorial representation of the specimen on the basis of optical sections through individual planes of the specimen.

The advantages of the SPIM technology consist, inter alia, in the greater speed with which the image information is captured, the lower risk of fading of biological specimens and an increased penetration depth of the focus into the specimen.

One of the main applications of light sheet microscopy lies in imaging mid-sized organisms, with dimensions of several 100 μm up to a few millimeters. As a rule, these organisms are embedded in agarose which, in turn, is situated in a glass capillary. The glass capillary is introduced into a water-filled specimen chamber from above or from below and the specimen is slightly pressed out of the capillary. The specimen in the agarose is illuminated by a light sheet and the fluorescence is imaged on a camera with a detection objective which is perpendicular to the light sheet and hence also perpendicular to the light sheet optical unit, as illustrated, for example, in Huisken et al. Development 136, 1963 (2009) “Selective plane illumination microscopy techniques in developmental biology” or in WO 2004/053558 A1.

This method of the light sheet microscopy has three big disadvantages. Firstly, the specimens to be examined are relatively large: Typical specimens originate from developmental biology. Moreover, the light sheet is relatively thick and the obtainable axial resolution consequently is restricted on account of the specimen preparation and the dimensions of the specimen chamber. Additionally, the specimen preparation is complicated and not compatible with standard specimen preparations and standard specimen holders as are conventional in the fluorescence microscopy of cells.

In order to partly circumvent these restrictions, a novel light sheet microscopy construction was realized in recent years, in which the illumination objective and the detection objective are perpendicular to one another and directed onto the specimen from above at an angle of α1 equals α2 equals 45°. By way of example, such a SPIM construction is disclosed in, for example, WO 2012/110488 A2 or WO 2012/122027 A2.

FIG. 1 schematically illustrates such an upright 45° SPIM configuration. Here, the specimen P1 is situated on the base of a Petri dish P2. The Petri dish is filled with a liquid P3, e.g. with water, and the two SPIM objectives, i.e. the illumination objective P4 and the detection objective P5, are immersed into the liquid P3. Such an arrangement offers the advantage of a higher resolution in the axial direction since a thinner light sheet P6 can be produced. Smaller specimens also may be examined on account of the higher resolution. Here, the specimen preparation has become substantially easier. However, it continues to be very disadvantageous that the specimen preparation and the specimen holder do not yet correspond to the standard specimen preparations and the standard specimen holders that are conventional in the fluorescence microscopy of cells. Thus, the Petri dish must be relatively large so that the two SPIM objectives can be immersed into the liquid situated in the Petri dish without abutting against the edge of the dish. Multiwell plates, which are the standard in many areas of biology, cannot be used by this method since the objectives cannot be immersed into the very small wells of the plate. Moreover, this method is disadvantageous in that e.g. screening with a high throughput is not readily possible since the objectives have to be cleaned when changing the specimen in order to avoid contamination of the various specimens.

These problems are avoided by the so-called inverse 45° SPIM configuration, as illustrated in FIG. 2. Although the 45° configuration is maintained in this case, the two SPIM objectives, i.e. the illumination objective P4 and the detection objective P5, now no longer are directed onto the specimen from above; instead, the specimen is illuminated, and the fluorescence is detected, from below through the transparent base of the specimen holder. Such an arrangement is disclosed in DE 10 2013 107 297 A1 and DE 10 2013 107 298 A1 by the applicant. As a consequence, it is possible to use all typical specimen holders, such as e.g. multiwell plates, Petri dishes and object carriers, and a contamination of the specimens during high throughput screening is no longer possible.

What is common to the two variants of the light sheet microscopy described here is that a light sheet is produced by one of the two SPIM objectives and the fluorescence is detected with the second of the two SPIM objectives. Here, the image plane of the detection objective lies in the light sheet, and so there is sharp imaging of the illuminated region on the detector.

In conventional wide-field microscopy, from which the light sheet microscopy was derived, methods by means of which a plurality of image planes can be imaged simultaneously on a detector are described. In “Multiplane imaging and three dimensional nanoscale particle tracking”, OptExpr-18-877-2010, Dalgarno et al. explain how a plurality of image planes can be imaged simultaneously on a detector with the aid of a special grating. In “Fast multicolor 3D imaging using aberration-corrected multifocus microscopy”, NatMeth-10-60-2013, Abrahamsson et al. describe how this can be solved with the aid of a special grating and with additional correction elements. To this end, a special phase grating is introduced into the detection beam path, by means of which the light originating from the entire specimen is resorted. Light from various planes, which are parallel to the original image plane, is refocused and imaged simultaneously on the detector on regions situated next to one another and below one another. Thus, the detector is divided into 3×3 fields, for example, and a plane is imaged in focus in each of these fields. However, a disadvantage in this case is that, relative to the respectively considered detection plane, out of focus light likewise is imaged, but not in focus, on the detector field of the corresponding detection planes.

An important specimen class that should be addressed using a light sheet microscope are specimens P1 which have layers of adherent cells on an object carrier P2, as illustrated in FIG. 3. The cells form a contiguous layer having a thickness d of approximately 20 to 30 μm. If there is illumination through this layer in accordance with the upright or inverse 45° configuration with a light sheet, only a region of the specimen with a length of approximately 30 to 40 μm is excited and correspondingly detected. Consequently, only a narrow stripe would be visible on the detector despite a field of view FOV of 200 μm.

By way of example, if the specimen has a thickness of 20 μm and the light sheet is radiated onto the specimen at 45°, the illuminated region within the specimen has a length of 28 μm. Now, if the numerical aperture of the detection objective is NA=1.1, the sampling frequency according to the Nyquist criterion accordingly is approximately 100 nm/pixel. Consequently, the illuminated region takes up 280 pixels on the detector. By way of example, if this were an sCMOS camera with 2560×2160 px (pco·edge), almost 9/10 of the sensor would remain unused.

### SUMMARY OF THE INVENTION

It is therefore an object of the present invention to describe an arrangement for light sheet microscopy and a method for light sheet microscopy, by means of which the recording speed can be increased significantly without impairing the imaging quality or increasing the radiation exposure of the specimen.

An arrangement for light sheet microscopy comprises a specimen plane for arranging a specimen. This specimen plane can be embodied by a specimen stage for placing or else for placing and anchoring the specimen. However, the specimen plane can also be determined by a specimen chamber or holder in which a specimen is held at a fixed position by anchoring e.g. in an opening of this specimen chamber or in the holder, and hence a specimen plane is defined. It is embodied in such a way that a specimen situated in the specimen plane can be illuminated without shadows being produced in a central part of the specimen by the construction of, for example, a specimen stage, a specimen chamber or any other specimen holder and that the radiation emitted by the specimen likewise can be detected without obstacles. Thus, the specimen plane is arranged in such a way that no obstacle arises in the optical path of the arrangement for the light sheet microscopy. This is obtained either by the choice of a suitable, optically transparent material for the specimen stage, the specimen chamber or the specimen holder, or at least for parts thereof which are situated in or in the vicinity of the optical path, or by appropriate apertures in the specimen stage, specimen chamber or specimen holder, for example in such a way that the specimen, an object carrier or a specimen vessel is illuminated directly and that radiation emitted by the specimen is directly detectable. Moreover, the specimen plane can have a movable embodiment such that its position in space is changeable in at least one direction, preferably in two or three directions of the space, which may be realized, for example, by a movement of the specimen stage, the specimen chamber or the specimen holder. The specimen can be prepared to assist fluorescence radiation from the specimen upon illumination with an appropriate light, and it can be situated in a transparent vessel or else on an object carrier, for example on a transparent plate or between two transparent plates, such as e.g. two glass plates.

An arrangement for light sheet microscopy furthermore comprises an illumination apparatus having a light source and an illumination optical unit. The illumination apparatus is configured for producing a first light sheet which extends in a non-parallel fashion in relation to the specimen plane, i.e., for example, not parallel to the plane of a specimen stage, for illuminating a first stripe of the specimen and for exciting fluorescence radiation in this first stripe of the specimen. By way of example, according to the principles of static light sheet microscopy (SPIM), such a light sheet can be produced by the use of a cylindrical lens. In principle, a light sheet also is producible by focusing a laser beam and quickly scanning this focused laser beam back and forth between two endpoints of a line that extends perpendicular to the optical axis (scanned laser light sheet fluorescence microscopy). The light or laser source used in the process produces monochromatic light. Here, it is possible to use light with a plurality of wavelengths, by means of which the specimen is illuminated, for example in a time-sequential manner, in respect of the different wavelengths. The illuminated stripe in the specimen arising from such a SPIM construction is very narrow. Typically, it has thicknesses from 0.1 μm to 10 μm, in particular thicknesses from 0.4 to 1 μm.

Finally, the arrangement for light sheet microscopy comprises a detection apparatus having a sensor, i.e. having a detector or a detection means, which is capable of detecting the fluorescence radiation emitted by the specimen. In this case, an area sensor or a different spatially resolving detection means is preferred, for the spatially resolved detection of the fluorescence radiation.

Moreover, the detection apparatus contains an imaging optical unit for imaging the fluorescence radiation emitted by the specimen into a detection plane of the sensor. Here, the detection plane is the plane in which the signals of the imaging are made available in the form in which they should be detected by the sensor.

In a preferred embodiment, the imaging optical unit contains an objective and a tube lens. The tube lens can be arranged at various positions in the detection beam path; thus, further optical elements may be situated between the objective and tube lens.

The detection apparatus has a detection axis. This detection axis forms an angle with the light sheet from an angle range of 70° to 110°, preferably from an angle range of 80° to 100°. An arrangement in which the detection apparatus has a detection axis that is perpendicular to the light sheet is particularly preferred.

According to the invention, the arrangement for the light sheet microscopy is characterized in that the illumination apparatus is configured to produce at least one further light sheet that is arranged parallel to the first light sheet, for illuminating a further stripe of the specimen and for exciting fluorescence radiation in this further stripe of the specimen. This further light sheet is displaced in relation to the first light sheet both in the detection direction, i.e. along the detection axis, and in the illumination direction.

In the arrangement according to the invention, the illumination direction, detection direction, and specimen plane form a triangle, wherein the angle between the illumination direction and the specimen plane and the distance between the parallel light sheets is advantageously chosen depending on the specimen thickness in such a way that the stripes of the specimen illuminated by the first light sheet and by the further light sheet do not lie over one another when seen in the detection direction.

Two or more parallel light sheets can be produced as follows: A laser module produces a laser beam. The laser beam can be Gaussian or, for example, be based on Bessel beams, Mathieu beams or sinc³ beams, i.e. on a non-diffraction-limited beam form. In the spatial frequency domain there is a spatial light modulator (SLM), which is illuminated by the laser beam. A phase pattern is encoded on the SLM in such a way that the phase pattern produces the spectrum of a plurality of parallel focus-displaced light sheets. The spectrum of the SLM plane is transferred into the spatial domain by means of a further lens. Here, there is filtering, for example by means of a stop. By means of lens arrangements following the stop plane and by means of a scanner allowing scanning in two directions, said stop plane is steered onto the specimen. This can be effectuated with the aid of a deflection mirror, which has disposed downstream thereof a tube lens and an illumination objective which image the light distribution present on the deflection mirror into the specimen.

By illuminating a specimen by way of a plurality of light sheets arranged parallel to one another, it is possible to increase the recording speed and the sensor can be used in an ideal manner since, for example, the light sheets can be arranged in such a way that various light sheets are able to use various sensor positions next to one another. Hence, the illumination by the plurality of light sheets can be effectuated simultaneously for the greatest possible increase in the recording speed. Here, simultaneously should also be understood to mean that the specimen is illuminated by the plurality of light sheets within a sensor detection time T, i.e., for example, within a camera exposure time. Such a sensor detection time usually lies in the range of 1 ms to 100 ms. This illumination can thus also be effectuated quickly sequentially, provided that all n (n>=2) light sheet exposures occur within T. Here, the illumination time for each of the light sheets can be chosen to be T/n; however, it is also possible to choose distributions for the individual light sheets that deviate therefrom, e.g. in order to compensate brightness differences if the plurality of light sheets have different colors. The detection apparatus in such an arrangement for light sheet microscopy is configured to carry out detections in two or more planes that are illuminated by a light sheet, i.e. to image in focus the stripes of the specimen illuminated by the light sheets. If these light sheets are used in a time-sequential manner and if the detection apparatus is matched thereto, it is possible, in principle, also to use a detection arrangement for an arrangement for light sheet microscopy according to the prior art, which has smaller modifications over the prior art, such as an easily and quickly modifiable objective focal spot. However, this does not ideally exploit the options for increasing the recording speed.

Therefore, the arrangement according to the invention for light sheet microscopy furthermore is characterized by a detection apparatus which is configured to detect simultaneously the fluorescence radiation excited in the first stripe of the specimen by the first light sheet and the fluorescence radiation excited in the further stripe of the specimen by the further light sheet. This means that the fluorescence radiation from the first stripe of the specimen, which was de-excited by the first light sheet, and the fluorescence radiation from the second stripe of the specimen, which was excited by the second light sheet, are imaged in focus and detected at the same time.

Furthermore advantageous is an arrangement according to the invention for light sheet microscopy having a detection apparatus which contains a first detection plane that is assigned to the first light sheet and a further detection plane that is assigned to the further light sheet. This detection apparatus is configured for simultaneous congruent coverage of a first focal plane of the first light sheet with the first detection plane and of a further focal plane of the further light sheet with a further detection plane. The focal plane is the plane of the sharp imaging by way of the imaging optical unit of the stripe of the specimen illuminated by the respective light sheet. It is also referred to as sharpness plane. Here, congruent coverage means that the respective focal plane is brought into correspondence or coverage with the associated detection plane. Such an arrangement now allows the simultaneous illumination of a specimen by a plurality of light sheets arranged parallel to one another with, at the same time, sharp imaging of all stripes illuminated by the light sheets.

Here, these signals are either detected directly in the detection plane or transmitted from the detection plane to the sensor, or imaged in a sensor plane, in such a way that said signals can be detected in identical form by the sensor. Hence, the detection plane also can be situated outside of the actual sensor if means which forward the signals received in the detection plane to the sensor are available between the detection plane and the sensor.

If additional means are required for the congruent coverage of the respective focal plane of a light sheet with its detection plane, these means need not be present for all light sheets in order to satisfy the condition specified here. The first light sheet, in particular, also can make do without additional means in appropriate configurations.

As a consequence, the arrangement according to the invention can be used to produce a further light sheet that is parallel to the first light sheet or else a plurality of further light sheets that are parallel to the first light sheet and it can overcome the different focal planes usually arising in the process, which would make simultaneous focused detection of all stripes of the specimen excited by various light sheets impossible. As a consequence, there is a substantial increase in the speed with which a specimen can be examined, the sensor of the detection apparatus is used in an ideal manner and, nevertheless, sharp imaging of all stripes of the specimen excited by the light sheets is achieved.

Thus, the preferred solution according to the invention is distinguished in that a plurality of light sheets simultaneously illuminate narrow stripes of the specimen. Here, the light sheets lie parallel to one another and are arranged perpendicular to the detection axis. However, they are displaced from one another in the detection direction, leading to differently long optical paths of the fluorescence radiation emitted by the specimen from the respective light sheet to the imaging optical unit of the detection apparatus. This leads to different focal planes of the stripes of the specimen that are illuminated by various light sheets, which is therefore taken into account in the construction and the function of the detection apparatus in such a way that stripes in the specimen illuminated with various light sheets are detected in various planes or signals ready for detection are recorded in various planes or the focal planes of the respective light sheets are moved by further optical elements into a uniform detection plane for all light sheets: Thus, for example, means which modify the phase of a light wave passing therethrough can be arranged in the detection apparatus, different focal planes can be compensated by spatial orientation displacements of parts of the sensor or different focal planes are counteracted by using different wavelengths for the respective light sheet.

In an advantageous embodiment, the arrangement according to the invention for the light sheet microscopy is configured in such a way that the fluorescence radiation excited by the first light sheet and the fluorescence radiation excited by the further light sheet arranged in parallel are not superposed on one another in the detection direction and a separate sensor position of the sensor, i.e. an exclusive detection region of the sensor, is assigned in each case to the first light sheet and the further light sheet. Thus, the projections of the light sheets in the detection direction do not overlap in this arrangement. In such an arrangement for light sheet microscopy having a plurality of light sheets parallel to one another, the detection of the fluorescence radiation excited in the various light sheets is less complex.

In a further embodiment, the arrangement according to the invention for light sheet microscopy is configured in such a way that the detection apparatus contains means for spectral detection or the detection apparatus contains means for confocal filtering, i.e. an “out of focus” suppression, or else the illumination apparatus contains means for structured illumination. This assists the separation of the fluorescence radiation incident on the sensor from various light sheets. In these cases, the projections of the light sheets in the detection direction may overlap wholly or partly.

Thus, if the sensor is capable of detecting light with different wavelengths and separating light depending on the wavelength, the first light sheet and the further light sheet, and optionally also a plurality of further light sheets, may have different wavelengths or else the specimen can contain two or more dyes that are excited by the light sheets.

If the mutually parallel light sheets have the same wavelengths even though they overlap in terms of their projections in the detection direction, means for background suppression are required for each of the light sheets or for the fluorescence radiation that is emitted in each of the stripes illuminated by one of the parallel light sheets. By way of example, out-of-focus components increasingly appear in the case of relatively thick specimens in the case of the proposed illumination by a plurality of parallel light sheets that are radiated-in simultaneously, said out-of-focus components originating from the other light sheets which are not imaged in focus in the respective sensor region.

It is possible to suppress out-of-focus light, and hence unfocused light, from the respective other specimen regions by confocal detection. To this end, use can be made, for example, of the “rolling shutter” method. “Rolling shutter” denotes the readout process of an “active pixel” image sensor in CMOS or sCMOS technology, i.e. in complementary metal oxide semiconductor technology or in scientific CMOS technology. In contrast to the CCD sensor, the pixels of these sensors are activated and read line-by-line or column-by-column such that the respective light-sensitive part of the area sensor is only formed by a narrow sensor stripe which quickly runs over the sensor region within an image exposure. If the scan movement of a line illumination is synchronized to this readout movement by light sheets that extend parallel to one another, a “virtual” confocal slot aperture is obtained therewith; out-of-focus light, and hence unfocused light, from other specimen regions is suppressed because it falls on the respectively currently inactive sensor regions in front of and behind the active pixel line of the “rolling shutter”.

Here, for thin specimens, a “rolling shutter” is utilizable for a plurality of light sheets. By contrast, in the case of relatively thick specimens or relatively long light sheets, it is advantageous to spatially offset a plurality of “rolling shutters” from one another by a suitable actuation and possibly to have these run offset from one another over a CMOS sensor when the specimen is scanned by the light sheets.

A further option for using light sheets that are parallel to one another, have the same wavelength and overlap in terms of their projections in the detection direction consists in a structured illumination. This is possible with incoherent structuring or else with coherent structuring.

In the case of incoherent structuring, a scanned light sheet is assumed, i.e. a light sheet which is spanned by the scanning process of a beam which is fast in relation to the sensor detection time, for example a camera exposure time. If the exposure by the laser is now interrupted at exactly defined times during this scanning process, a grating can be “written into the specimen”.

By contrast, the grating or the structuring is produced by interference in the case of coherent structuring.

An advantageous configuration of the arrangement according to the invention for light sheet microscopy has a detection apparatus which contains a phase element for congruent coverage of the first focal plane with the first detection plane and congruent coverage of the further focal plane with the further detection plane. The use of a phase element constitutes a relatively simple solution for moving the focal plane by means of an optical function inscribed therein into the detection plane. Here, the phase element is brought into the detection beam path between the detection objective and the sensor. Depending on the selection of the phase element, refocusing of the images of the individual light sheets is possible in order to facilitate even sharper imaging. This is the case if the phase element is correspondingly regulable.

All arrangements for light sheet microscopy which comprise phase elements in the detection beam path for superposing a first focal plane with the first detection plane and a further focal plane with the further detection plane, i.e. for bringing these into congruent coverage, allow the illumination of the specimen with more than two mutually parallel light sheets. They can be used in such a way that simultaneous illumination by a plurality of light sheets, simultaneous congruent coverage of the respective focal planes with the respective detection planes of the light sheets, and hence a simultaneous detection of all stripes illuminated by the light sheets is possible. However, they can also be used for a time-sequential detection of a plurality of light sheets if the detection planes of the various light sheets are run over very quickly in succession by way of a regulable phase element, which very high speed cannot be met if elements of the detection apparatus have to be moved mechanically.

A first option for arranging a phase element in the detection apparatus of the arrangement according to the invention for light sheet microscopy, the imaging optical unit of which contains an objective, is the arrangement of a phase grating in a detection beam path between the objective and the sensor.

Then, only the stripe illuminated by the first light sheet is imaged in focus on the sensor at a first position in a region assigned to the first light sheet. By contrast, the stripe illuminated by a further light sheet is imaged out of focus at a second position in the region assigned to the first light sheet. However, only the positions in the region of the sensor assigned to the respective light sheet which are imaged in focus are taken into account for reconstructing a corresponding image of the specimen.

Moreover, further correction elements in addition to the phase grating may be inserted into the detection beam path.

Moreover, such arrangements are possible in the 45° SPIM configuration, in the inverse 45° SPIM configuration and in a conventional SPIM configuration.

A further option for arranging a phase element in the detection apparatus of the arrangement according to the invention for light sheet microscopy lies in the arrangement of a spatial light modulator (SLM) with a phase function in a spatial frequency domain such as, for example, in the pupil of an objective of the imaging optical unit. In this case, a combined transfer function is ascertained for each light sheet from the multiplication of individual transfer functions of optical basic elements. Here, an overall phase function which should be encoded into the spatial light modulator emerges from the addition of the combined transfer functions of all light sheets used to illuminate the specimen.

Additionally, a correction element can be arranged in the beam path for chromatic correction purposes.

Alternatively, there can be such a spatial light modulator (SLM) with a phase function in spatial domain, i.e., for example, in an intermediate image plane. In this case, the phase function can reproduce a microlens array. This arrangement is advantageous in that all photons emitted in the stripes of the specimen excited by the light sheets can be used for the detection.

In an alternative configuration, the arrangement according to the invention for light sheet microscopy has a detection apparatus which achieves the congruent coverage of the first focal plane with the first detection plane and of the further focal plane with the further detection plane in a geometric way by virtue of the detection apparatus containing a sensor that is configured in such a way that a first sensor region is assigned to the first light sheet and a further sensor region is assigned to the further light sheet, wherein the further sensor region is arranged relative to the first sensor region in a manner displaced along the detection axis. Thus, the individual sensor regions are arranged in a step-shaped manner in relation to one another and together form a step sensor, wherein the height and width of the steps are chosen in such a way that in each case the first stripe of the specimen illuminated by a first light sheet is imaged in focus on the first sensor region and the further stripe of the specimen illuminated by a further light sheet is imaged in focus on a further sensor region. Here, such a sensor region can be operable in an autonomous fashion, or else it can be part of a step sensor which is actuated in a uniform manner.

All arrangements for light sheet microscopy which comprise a step sensor or sensor regions arranged in a step-shaped manner in relation to one another in the detection beam path for bringing a first focal plane with the first detection plane and a further focal plane with the further detection plane into congruent coverage allow the illumination of the specimen with more than two mutually parallel light sheets. They can be used in such a way that simultaneous illumination by a plurality of light sheets, simultaneous congruent coverage of the respective focal planes with the respective detection planes of the light sheets, and hence a simultaneous detection of all stripes illuminated by the light sheets is possible. However, they also can be used for a time-sequential detection.

In a further alternative configuration, the arrangement according to the invention for light sheet microscopy has a detection apparatus which achieves the congruent coverage of the first focal plane with the first detection plane and of the further focal plane with the further detection plane by virtue of the detection apparatus comprising a fiber plate containing glass fibers, the first ends of which are arranged for input coupling of the imaged fluorescence radiation and the opposite ends of which either are in direct contact with the sensor or are imageable on the sensor by optical means.

Here, the fiber plate contains a first fiber plate portion assigned to the first light sheet and a further fiber plate portion assigned to the further light sheet, the ends of said further fiber plate portion for input coupling being arranged in a manner displaced along the detection axis. Thus, this fiber plate also has such a step-shaped embodiment that the stripe of the specimen illuminated by the first light sheet is imaged in focus on a first portion of the fiber plate and the stripe of the specimen illuminated by the further light sheet is imaged in focus on a further portion of the fiber plate that is separated from the first portion by a step.

Thus, the respective stripe excited by a light sheet is imaged in focus in this case on the associated step of the fiber plate. The light is input coupled into the glass fibers of the plate and guided to the opposite flat side of the fiber plate. There, it is detected directly by the sensor or it is imaged on the detector by a further imaging optical unit.

All arrangements for light sheet microscopy which comprise a fiber plate with a step-shaped configuration in the detection beam path for bringing a first focal plane with the first detection plane and a further focal plane with the further detection plane into congruent coverage allow the illumination of the specimen with more than two mutually parallel light sheets. They can be used in such a way that simultaneous illumination by a plurality of light sheets, simultaneous congruent coverage of the respective focal planes with the respective detection planes of the light sheets, and hence a simultaneous detection of all stripes illuminated by the light sheets is possible. However, they also can be used for a time-sequential detection.

In a further alternative arrangement for light sheet microscopy, the detection apparatus comprises a microlens array between an objective of the imaging optical unit and the sensor, for the congruent coverage of the first focal plane with the first detection plane and of the further focal plane with the further detection plane. The microlens array has such a configuration that a first microlens of a first type with a first refractive power is assigned to the first light sheet and a further microlens of the microlens array of a further type with a further refractive power is assigned to the further light sheet. Here, the first refractive power of the first microlens is dependent on the spatial orientation of the first focal plane and the further refractive power of the further microlens is dependent on the spatial orientation of the further focal plane. The microlens array is arranged in the detection beam path in such a way that it images the respective focal plane into a common sensor plane.

The arrangements for light sheet microscopy which contain a microlens array in the detection beam path between an objective of the imaging optical unit and the sensor for bringing a first focal plane with the first detection plane and a further focal plane with the further detection plane into congruent coverage also allow the illumination of the specimen with more than two mutually parallel light sheets. They can be used in such a way that simultaneous illumination by a plurality of light sheets, simultaneous congruent coverage of the respective focal planes with the respective detection planes of the light sheets, and hence a simultaneous detection of all stripes illuminated by the light sheets is possible. However, they also can be used for a time-sequential detection.

In a further alternative arrangement for light sheet microscopy, the detection apparatus comprises a beam splitter in a detection beam path, said beam splitter preferably being arranged behind an objective of an imaging optical unit, for the congruent coverage of the first focal plane with the first detection plane and of the further focal plane with the further detection plane. Here, the beam splitter is arranged in the detection beam path in such a way that it divides the beam path and a first focal plane assigned to the first light sheet and a further focal plane assigned to a further light sheet are imaged next to one another on the sensor. Moreover, the arrangement can comprise a first tube lens assigned to a first light sheet and a further tube lens assigned to the further light sheet, or else other optical elements assigned to the respective light sheet instead of the tube lenses. The signals which are emitted from the stripe of the specimen illuminated by a further light sheet are deflected by the beam splitter, for example to the further tube lens, as a rule using a further mirror or another arrangement which facilitates another directional change of the radiation deflected by the beam splitter such that the beam path of the first light sheet and of the further light sheet ultimately can be detected next to one another on a sensor. To this end, either the first light sheet and the second light sheet must be produced with respectively different wavelengths or the specimen must contain different dyes which can emit fluorescence radiation such that fluorescence radiation with respectively a different wavelength is emitted from the respective illuminated stripes from different light sheets.

In principle, it is also possible in such an arrangement to illuminate the specimen with more than two light sheets that are parallel to one another. However, this would mean a significantly more complicated construction having further beam splitters and additional arrangements for changing the direction of the deflected radiation. Such an arrangement can be used in such a way that simultaneous illumination by a plurality of light sheets, simultaneous congruent coverage of the respective focal planes with the respective detection planes of the light sheets, and hence a simultaneous detection of all stripes illuminated by the light sheets is possible. However, it also can be used for a time-sequential detection.

A preferred arrangement for light sheet microscopy is configured to carry out a volume scan of the specimen. Using such an arrangement, it is possible to record the entire volume of a specimen. For these purposes, the arrangement contains means for carrying out a relative movement between the light sheets and the specimen. These render it possible to record a z-stack for each light sheet. By way of example, such means are a movable specimen plane or an object carrier that is movable in a fixed specimen plane, which object carrier is displaceable in the x-direction, y-direction or z-direction or in a combination of these three directions. However, a relative movement can also be realized by means of at least one scanner and optional further means for the beam deflection, by means of which the light sheets are displaced in a fixed specimen.

The individual z-stacks are combined by calculation to a three-dimensional volume during or after the recording, in which volume an overall image of the specimen is imaged. For these purposes, the arrangement for light sheet microscopy contains a control and calculation unit.

Here, a first, particularly preferred arrangement for light sheet microscopy configured to carry out a volume scan of the specimen contains means for carrying out a relative movement between the light sheets and the specimen along an axis parallel to an object carrier. Such an arrangement allows a short light sheet length. Moreover, the energy influx into the specimen volume is very low and, consequently, fading of the specimen and other phototoxic influences are kept as low as possible.

A further arrangement for light sheet microscopy configured to carry out a volume scan of the specimen contains means for carrying out a relative movement between the light sheets and the specimen along an axis parallel to the detection direction. A short light sheet length also can be used in such an arrangement.

A third arrangement for light sheet microscopy configured to carry out a volume scan of the specimen contains means for carrying out a relative movement between the light sheets and the specimen along an axis perpendicular to an object carrier.

Here, it is possible that relative movements also can be carried out along a plurality of axes by means of a special arrangement for light sheet microscopy which is configured to carry out a volume scan of the specimen.

The first light sheet and the further light sheet of an arrangement for light sheet microscopy can be based, for example, on Gaussian beams or Bessel beams or Mathieu beams or sinc³ beams.

In a special arrangement for light sheet microscopy, furthermore, a length of the first light sheet and/or of the further light sheet is matched to a thickness of the specimen.

In a method according to the invention for light sheet microscopy, a specimen is illuminated by at least two light sheets that are arranged parallel to one another and perpendicular to a detection axis. These light sheets produce fluorescence radiation in the stripes of the specimen assigned to the respective light sheets, said fluorescence radiation being imaged in a focal plane using an imaging optical unit and being detected by a sensor. Here, for the purposes of detecting the fluorescence radiation of the respective stripe of the specimen, the focal plane of one light sheet is brought into correspondence with a detection plane of the respective light sheet, wherein the fluorescence radiation excited in the respective stripes of the specimen is detected at the same time.

This can be effectuated by displacing the respective detection plane into the focal plane of the respective light sheet in a real manner, for example by the use of sensor regions that are displaced with respect to one another along the detection axis, wherein respectively one sensor region is used for the detection of one light sheet, or in an ideal manner, for example by the use of a fiber plate that contains glass fibers for transmitting the received signal and has a step-shaped construction, said fiber plate receiving the signals in the focal plane and transmitting these to the sensor, where the signals received in the detection plane are then in fact detected.

Alternatively, this can be effectuated by displacing or imaging the focal plane of the respective light sheet into a fixed detection plane, for example by using an additional microlens array, in which respectively one microlens is assigned to a light sheet and the refractive power of said microlens is correspondingly matched such that sharp imaging of the stripe of the specimen that is illuminated by the respective light sheet onto the sensor is effectuated.

In a preferred configuration of the method for light sheet microscopy, use is made of an above-described arrangement according to the invention for light sheet microscopy.

### BRIEF DESCRIPTION OF THE DRAWINGS

FIG. 1 shows an upright light sheet microscope in a 45° configuration according to the prior art, as described above.

FIGURE shows an inverse light sheet microscope in a 45° configuration according to the prior art, as described above.

FIG. 3 shows, in an exemplary manner, adhering cells on an object carrier which hence form a thin specimen, as described above.

FIG. 4 shows a first exemplary embodiment of the arrangement according to the invention for light sheet microscopy.

FIG. 5 shows an SLM phase function and the composition thereof for a variation of the second exemplary embodiment of the arrangement according to the invention for light sheet microscopy.

FIG. 6 shows a second exemplary embodiment of the arrangement according to the invention for light sheet microscopy.

FIG. 7 shows a third exemplary embodiment of the arrangement according to the invention for light sheet microscopy.

FIG. 8 shows a fourth exemplary embodiment of the arrangement according to the invention for light sheet microscopy.

FIG. 9 shows a fifth exemplary embodiment of the arrangement according to the invention for light sheet microscopy.

FIG. 10 shows a sixth exemplary embodiment of the arrangement according to the invention for light sheet microscopy.

FIG. 11 shows a seventh exemplary embodiment of the arrangement according to the invention for light sheet microscopy.

FIGS. 12a, 12b and 12c show various scanning regimes for a volume scan of a specimen using an arrangement according to the invention for light sheet microscopy.

FIG. 13 shows an exemplary embodiment of an apparatus for producing parallel light sheets for an arrangement according to the invention for light sheet microscopy.

FIG. 14 shows an SLM phase function and the composition thereof for the production of parallel light sheets by means of the exemplary embodiment of an apparatus for producing parallel light sheets.

FIG. 15a shows an eighth exemplary embodiment of the arrangement according to the invention for light sheet microscopy, in a plan view with a sensor configured for confocal detection.

FIG. 15b shows the sensor of the eighth exemplary embodiment in a front view.

FIG. 16a shows a ninth exemplary embodiment of the arrangement according to the invention for light sheet microscopy, in a plan view with a sensor configured for confocal detection.

FIG. 16b shows the sensor of the ninth exemplary embodiment in a front view.

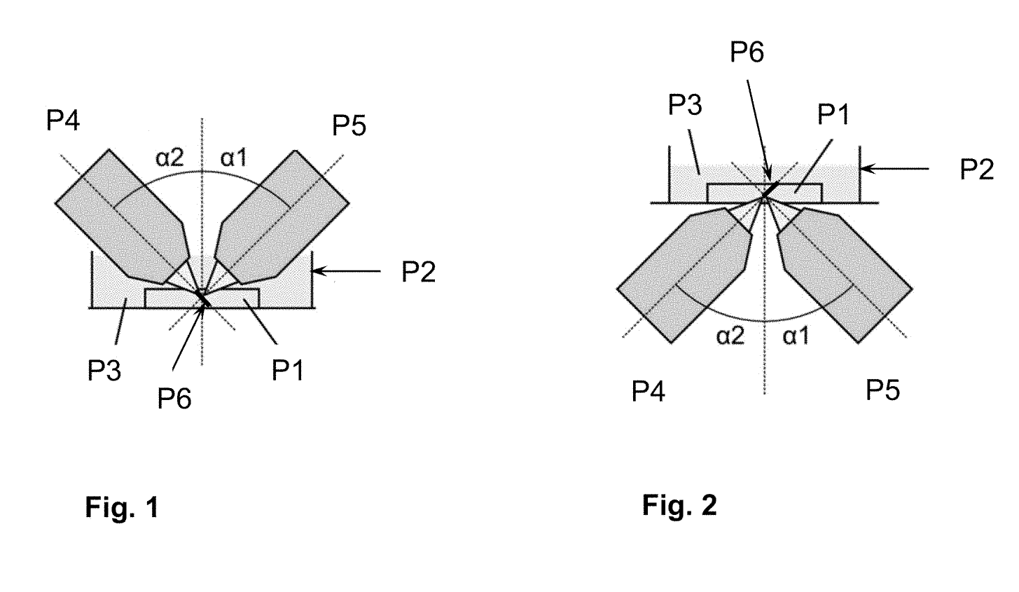

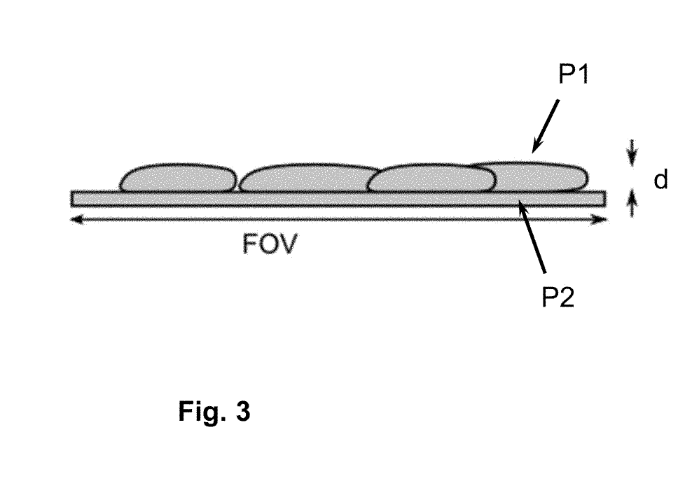

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

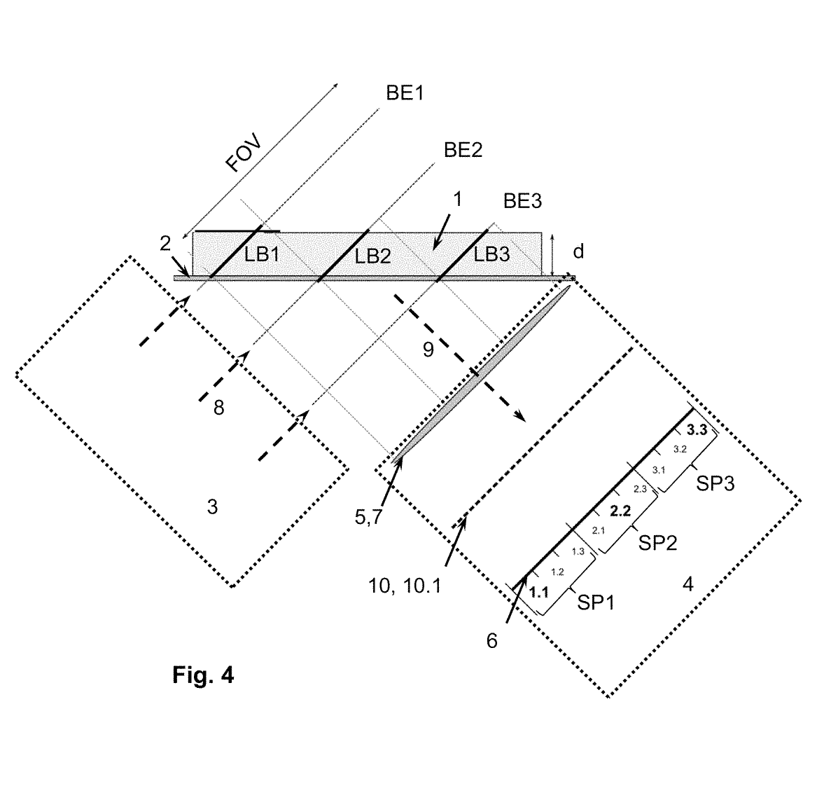

All solutions according to the invention for the arrangement for light sheet microscopy have an illumination apparatus 3, in which a plurality of mutually parallel light sheets LB1, LB2, LB3 are produced for illuminating mutually parallel stripes of the specimen 1. The illumination direction 8 is respectively noted in FIGS. 4 and 6 to 11. While the production of such parallel light sheets LB1, LB2, LB3 is discussed with reference to FIGS. 13 and 14, FIG. 4 to FIG. 11 initially describe exemplary embodiments of the arrangement according to the invention for light sheet microscopy, which allow all stripes of the specimen 1 that are illuminated by the parallel light sheets LB1, LB2, LB3 to be imaged simultaneously in focus.

FIG. 4 shows a first exemplary embodiment of the arrangement according to the invention for light sheet microscopy. In this example, the arrangement of an inverse light sheet microscope in a 45° configuration is used with the aid of a phase element 10, in this case a phase grating 10.1, for simultaneously imaging a plurality of planes of a specimen 1, i.e. a plurality of stripes of the specimen illuminated by mutually parallel light sheets LB1, LB2, LB3. The specimen 1 is situated on an object carrier 2 in a specimen plane 2.1 (not illustrated in FIG. 4). It has a thickness d of approximately 20 μm. By way of example, the specimen 1 is illuminated by three light sheets LB1, LB2, LB3, which each have a length of approximately 35 μm. Each of the light sheets LB1, LB2, LB3 defines an associated image plane BE1, BE2, BE3. Since the field of view FOV of an employed camera sensor 6 is approximately 200 μm, it is possible to simultaneously image three planes, i.e. the stripes of the specimen 1 excited by three light sheets LB1, LB2, LB3, in this case.

Now, a phase grating 10.1 is arranged in the detection beam path along the detection axis 9. This phase grating 10.1 has such an effect on the imaging that, firstly, the individual image planes BE1, BE2, BE3 are positioned next to one another and/or below one another on the sensor 6 of the camera such that the images of the individual image planes BE1, BE2, BE3 do not overlap. Thus, sensor positions SP1, SP2, SP3 are respectively reserved on the sensor 6 for each light sheet LB1, LB2, LB3. Secondly, there additionally is refocusing such that the corresponding image plane BE1, BE2, BE3, and hence, in particular, the corresponding stripe of the specimen 1 excited by the respective light sheet LB1, LB2, LB3, is imaged in focus on the respective region of the sensor SP1, SP2, SP3.

Here, the entire image plane BE1 is imaged on the sensor 6 at the position SP1, the image plane BE2 is accordingly imaged onto the sensor position SP2 and the image plane BE3 is imaged onto the sensor position SP3. Since the light sheets LB1, LB2, LB3 are positioned in such a way that the detected fluorescence of the stripes of the specimen 1 illuminated by the individual light sheets LB1, LB2, LB3 does not overlap, the stripe illuminated in the specimen 1 by the light sheet LB1 is imaged on the sensor 6 in a sub-position 1.1 in the region of the sensor position SP1, without interfering out-of-focus light from the light sheets LB2 and LB3. The fluorescence from the light sheets LB2 and LB3 is imaged out of focus onto the sub-positions 1.2 and 1.3. Accordingly, a sharp image of the stripes of the specimen illuminated by the light sheets LB2 and LB3 without interfering out-of-focus light is obtained on the sub-positions 2.2 and 3.3, respectively, in the region of the sensor positions SP2 and SP3, respectively.

In this arrangement, further correction elements can be introduced in addition to the grating. Moreover, this method is not restricted to a 45° configuration but, in principle, also can be applied to a standard light sheet microscope in the case of appropriate specimen positioning. The only disadvantage of such a configuration of the arrangement according to the invention for light sheet microscopy as described in the first exemplary embodiment is that the available light is not used in an ideal manner. This is shown by the fact that the photons from e.g. the light sheet LB1 are subdivided among all three sensor positions SP1, SP2, SP3 of the sensor 6 but only the sub-position 1.1 is used for the specimen reconstruction. Consequently, only 1/n of the emitted photons in fact are used, where n is the number of imaged planes or the number of light sheets used for the illumination.

The properties of the phase grating 10.1 used in the first exemplary embodiment also can be obtained by a spatial light modulator (SLM) 10.2 with an appropriate phase function and illumination. Here, the phase function emerges from a superposition of fundamental phase functions.

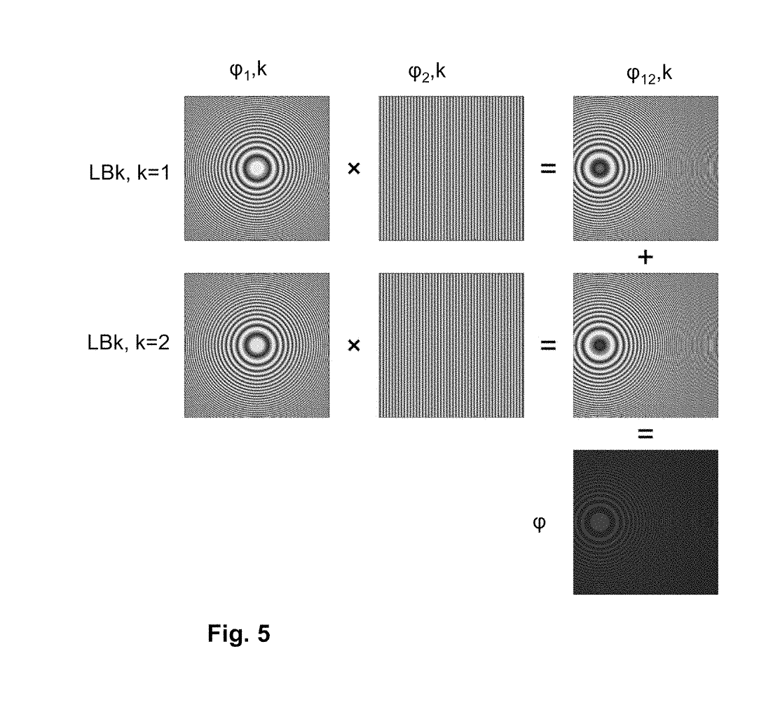

In FIG. 5, the construction of such an SLM phase function or the composition thereof from individual components, i.e. the fundamental phase functions, is illustrated using the example of two light sheets.

A defocus transfer function

$${T}_{1} ( r ) = exp ( \frac{π {ir}^{2}}{{f}_{1}} )$$

the focal length f₁ of a virtual lens, which is selected such that the light sheet plane is imaged in focus, and r=\sqrt{x²+y²}, where x predetermines the x-coordinate of the SLM and y predetermines the y-coordinate of the SLM, and the coordinates of the SLM describe the respective pixels, is designed in such a way that the respective illuminated plane is imaged in focus on the sensor 6 or on a detector. The image is placed on the respective site on the sensor 6 with the aid of the transfer function of a blazed grating or of a wedge T₂(x,y)=exp(ixdₓ+iyd_{y}), with the position dx of the image on the sensor 6 or on the sensor chip in x and the position dy of the image on the sensor 6 or on the sensor chip in y. The combination, i.e. the combined transfer function, emerges from multiplying the individual transfer functions T₁₂=T₁·T₂. The combined transfer function T_{12,k} is calculated for all light sheets k=1, 2, 3, . . . , n. The overall phase function φ, which is ultimately transferred onto the spatial light modulator (SLM), emerges from adding the individual combined transfer functions to form a complex overall transfer function T=Σₖ₌₁ⁿ T_{12,k} and from ascertaining the angle of this complex transfer function T with φ=angle(T).

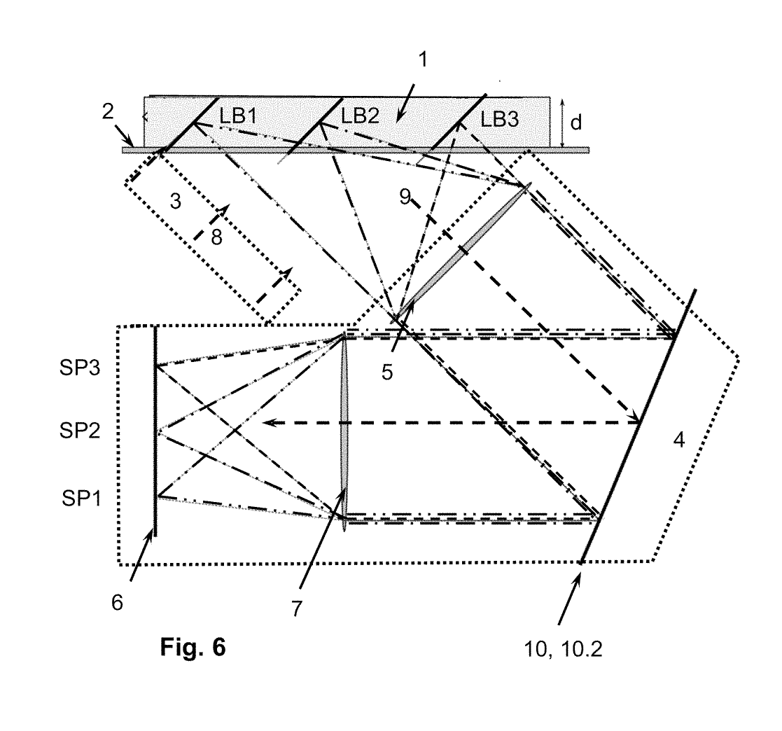

FIG. 6 shows a second exemplary embodiment of the arrangement according to the invention for light sheet microscopy. In this example, the arrangement of an inverse light sheet microscope in a 45° configuration is used once again, but in this case with the aid of a spatial light modulator (SLM) 10.2 for simultaneously imaging a plurality of stripes of the specimen illuminated by mutually parallel light sheets LB1, LB2, LB3. The specimen 1 is situated on an object carrier 2. Here, the SLM 10.2 is situated in the detection apparatus 4 in a frequency domain, i.e., for example, in the pupil of an objective 5 of the imaging optical unit 5, 7. The stripes of the specimen 1 illuminated by the three light sheets LB1, LB2, LB3 are imaged via a tube lens 7 on a sensor 6 once again, in the sensor position SP1, SP2, SP3 assigned to the respective light sheet LB1, LB2, LB3.

Like in the first exemplary embodiment too, this imaging onto the sensor positions SP1, SP2, SP3 that are used for the overall representation of the specimen 1 is accompanied, once again, by the use of only 1/n of the emitted photons for a number of n imaged planes or n light sheets arranged parallel to one another for illuminating the specimen 1. Here too, a correction element additionally can be introduced into the beam path for chromatic correction purposes.

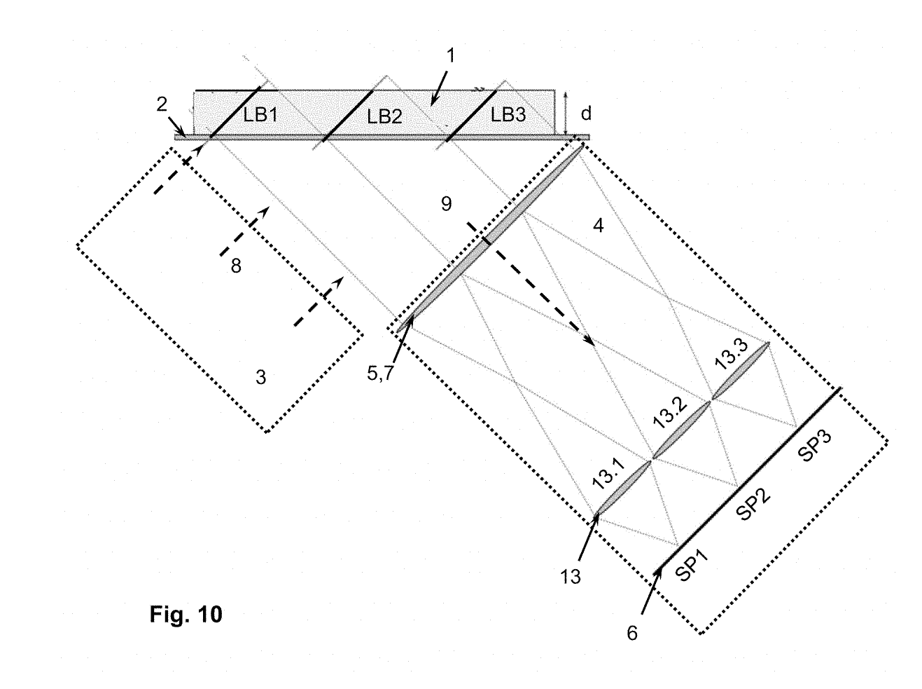

In a manner analogous to the sixth exemplary embodiment illustrated below, which is illustrated in FIG. 10, a spatial light modulator (SLM) 10.2, however, also can be arranged in the intermediate image instead of a microlens array 13 in one variation and said SLM can reproduce the phase function of a microlens array 13 there. This approach is advantageous in that all photons emitted in the specimen can be used for the detection.

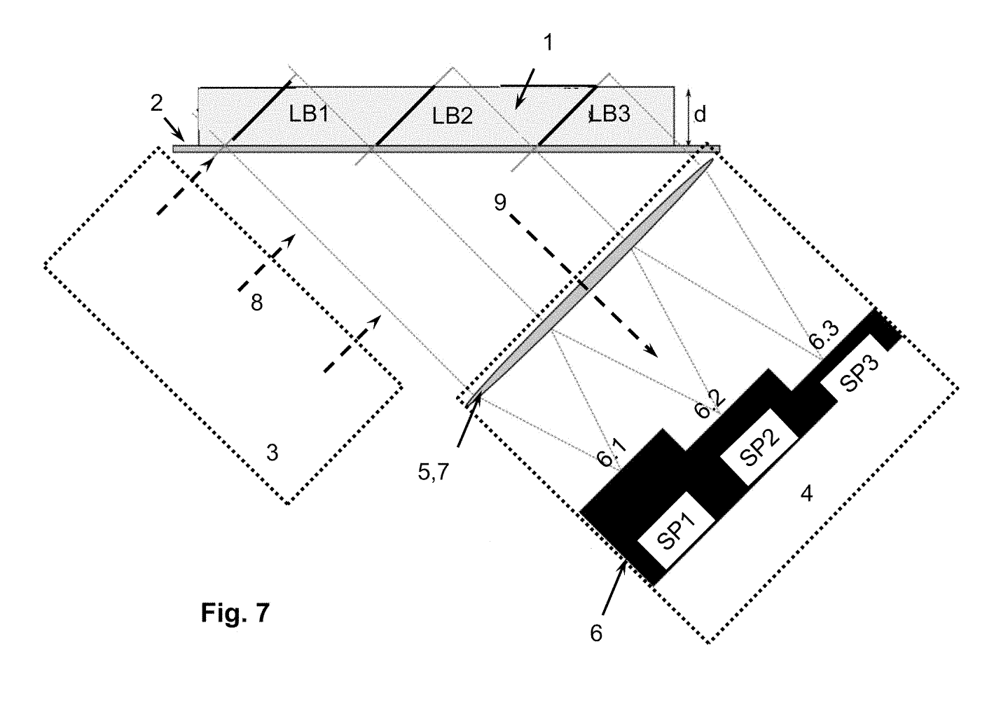

FIG. 7 shows a third exemplary embodiment of the arrangement according to the invention for light sheet microscopy, once again in the arrangement of an inverse light sheet microscope in a 45° configuration, although this should not restrict this configuration of the arrangement according to the invention for light sheet microscopy to this inverse 45° arrangement. The specimen 1 with a thickness d of several 10 μm is situated, once again, on an object carrier 2.

For the purposes of simultaneously imaging three planes of a specimen 1, i.e. three stripes of the specimen 1 that are illuminated by mutually parallel light sheets LB1, LB2, LB3, three sensors 6.1, 6.2, 6.3 are used in the third exemplary embodiment, said sensors being arranged at different distances from the tube lens 7 of the detection apparatus 4 such that the focal plane of the respective light sheet LB1, LB2, LB3 coincides with the detection plane of the respective sensor 6.1, 6.2, 6.3. A development hereof, as illustrated specifically in FIG. 7, lies in the use of a stepped sensor, i.e. a sensor 6 which does not form a plane surface but has steps 6.1, 6.2, 6.3. Here, the height and width of the steps 6.1, 6.2, 6.3 of the stepped sensor is adapted in such a way that the stripes of the specimen 1 that are illuminated by the light sheet LB1, LB2 and LB3 is respectively imaged in focus on the corresponding steps, i.e. the sensor positions SP1, SP2 and SP3, respectively.

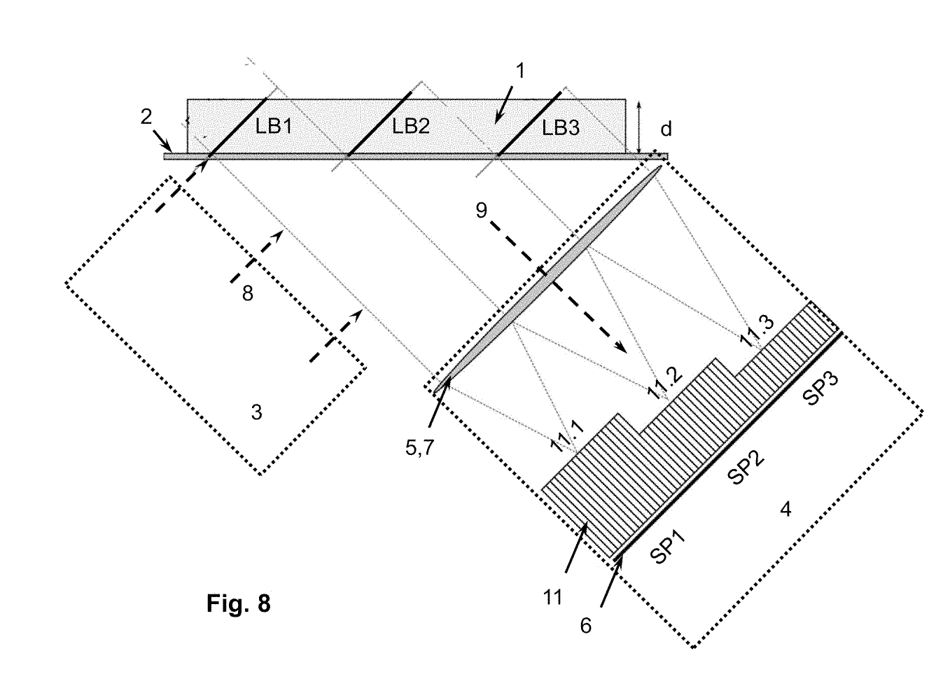

A fourth exemplary embodiment of the arrangement according to the invention for light sheet microscopy is illustrated in FIG. 8. In this example, use also is made of an inverse 45° light sheet microscope configuration; however, this should not restrict this embodiment of the arrangement according to the invention to this configuration either. The specimen 1 is situated, once again, on an object carrier 2.

With the aid of a fiber plate 11 containing glass fibers for light guidance, three stripes of the specimen 1 that are illuminated by mutually parallel light sheets LB1, LB2, LB3 are simultaneously imaged in focus by way of an objective 5 of the detection apparatus 4 and are detected by the sensor 6. To this end, the fiber plate 11 has a step-shaped form. The stripe of a specimen 1 illuminated by the respective light sheet LB1, LB2 or LB3 is respectively imaged in focus on the step of this step-shaped fiber plate 11 that belongs to this light sheet LB1, LB2 or LB3, i.e. on its fiber plate portion 11.1, 11.2, 11.3, on which the focal plane of the respective light sheet LB1, LB2 or LB3 is incident. The light is input coupled into the glass fibers of the fiber plate 11 and guided to the opposite flat side of the fiber plate 11. Here, there is situated a flat sensor 6, which is in direct contact with the flat side of the fiber plate 11 or situated at a small distance of a few micrometers from this fiber plate 11 and which detects the signals guided onto the sensor 6 by the glass fibers —at the sensor positions SP1, SP2, SP3 provided for the respective light sheet LB1, LB2, LB3.

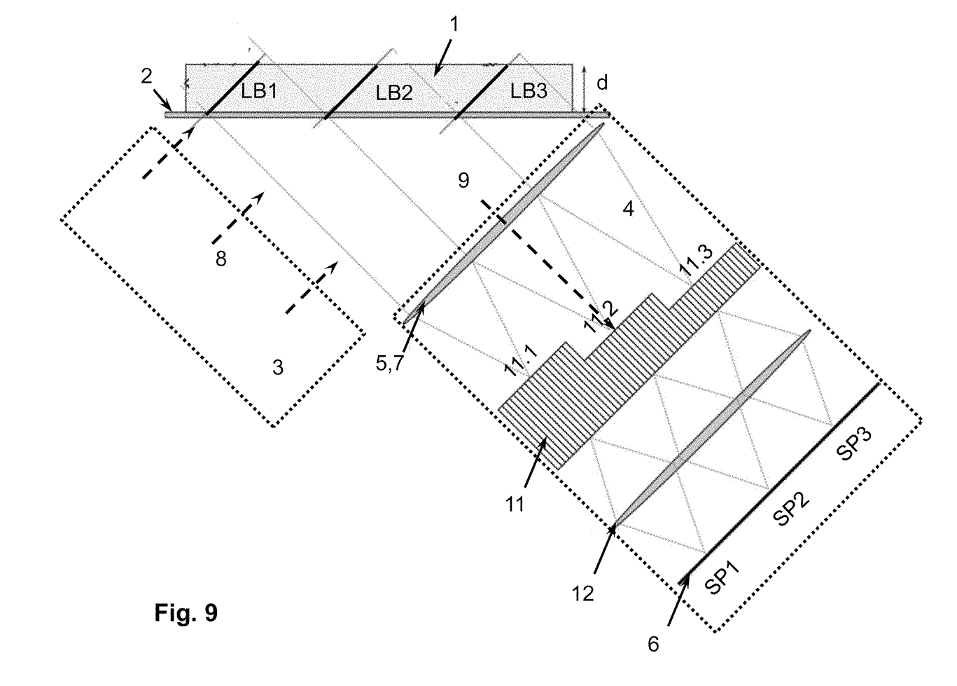

As a development of the fourth exemplary embodiment, FIG. 9 shows a fifth exemplary embodiment of the arrangement according to the invention for light sheet microscopy, in which there is, once again, a step-shaped fiber plate 11 with the fiber plate portions 11.1, 11.2, 11.3 assigned to the light sheets LB1, LB2, LB3 situated along the detection axis 9 in the detection beam path of the detection apparatus 4 in such a way that each of the three light sheets LB1, LB2, LB3 is imaged in focus on its fiber plate portion 11.1, 11.2, 11.3, i.e. on a step of the fiber plate 11, the light, in turn, being coupled into the glass fibers and finally being imaged in focus onto a sensor 6 or detector by the rearward, flat side of the fiber plate 11 by means of a telescopic lens 12 additionally arranged in the detection beam path.

The individual glass fibers of the fiber plate 11 need not necessarily be straight either in the fourth exemplary embodiment or in the fifth exemplary embodiment. It is also conceivable for the glass fibers to be bent and hence for the end surface of the fiber plate 11 no longer to be perpendicular to the original detection axis 9. This does not change the imaging properties but does provide freedoms in the construction and design of such an arrangement for light sheet microscopy: Then, the sensor 6 or detector can be placed where desired.

FIG. 10 shows a sixth exemplary embodiment of the arrangement according to the invention for light sheet microscopy. With similar design to the arrangements of the exemplary embodiments already described above, the same reference signs herein also denote the same features. In the sixth exemplary embodiment of the arrangement according to the invention for light sheet microscopy, a microlens array 13 is arranged in an intermediate image plane in the detection beam path between the tube lens 7 and the sensor 6. The specimen 1 is illuminated, once again, by three light sheets LB1, LB2, LB3. Each microlens 13.1, 13.2, 13.3 of the microlens array is assigned to a light sheet LB1, LB2, LB3. The microlenses 13.1, 13.2, 13.3 have a correspondingly different refractive power and correct the defocusing of the respective plane assigned to a light sheet LB1, LB2, LB3. As a result, all three illuminated stripes of the specimen 1 are imaged in focus into the corresponding sensor position SP1, SP2, SP3 on a flat sensor 6.

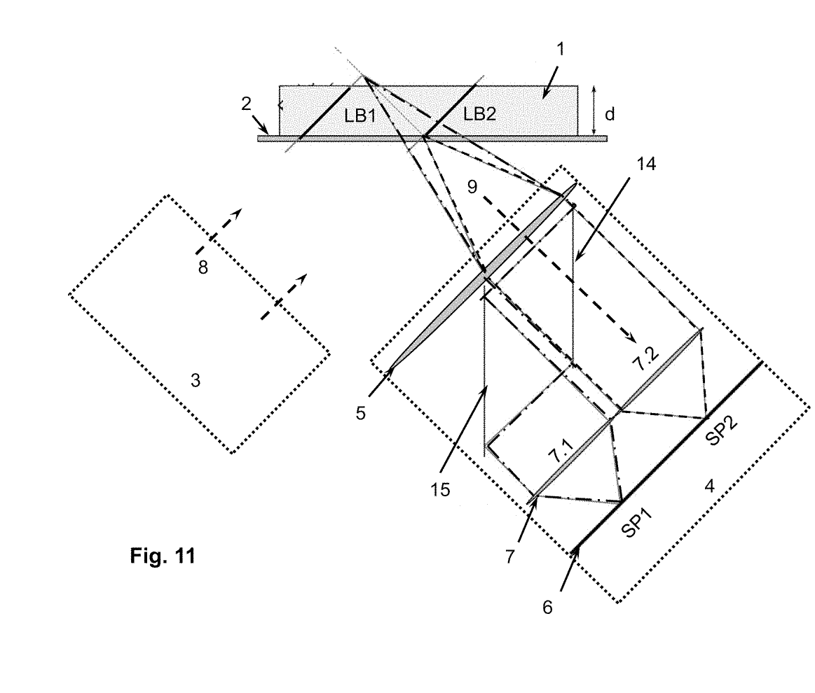

FIG. 11 illustrates a seventh exemplary embodiment of the arrangement according to the invention for light sheet microscopy, in an inverse 45° configuration with a bi-plane detection for simultaneously imaging two stripes of the specimen 1 that are illuminated by mutually parallel light sheets LB1, LB2, LB3. The specimen 1 with a thickness d of 20 μm is situated, once again, on an object carrier 2.

DE10 2009 060 490 A1 by the applicant describes a method for three-dimensional photo-activated localization microscopy (3D-PALM) and a corresponding microscope. Similar to the bi-plane approach of 3D-PALM, both planes also can be imaged on a sensor 6 with a light sheet microscope, in which two stripes of a specimen 1 are illuminated by two light sheets LB1, LB2 that are arranged parallel to one another. To this end, a beam splitter 14 which divides the detection beam path into two partial beams and a mirror which steers the second partial beam deflected by the beam splitter 14 onto the sensor 6 again are inserted into the detection beam path. The partial beams are imaged next to one another in corresponding sensor positions SP1, SP2 on the sensor 6 of the camera by means of a tube lens 7.1, 7.2, wherein different planes in the specimen 1 are imaged in focus as a result of differently long optical paths. In the case of two partial beams, the beam splitter 14 can be, for example, a 50:50 beam splitter 14 or else a wavelength-dependent beam splitter 14. In the latter case, work should be undertaken with fluorescence radiation with different wavelengths from the stripes of the specimen 1 illuminated by the two light sheets LB1, LB2. Similar to DE 10 2009 060 490 A1, embodiments with variably adjustable object plane distances are possible.

Such an arrangement in the detection apparatus 4 is also possible as a multi-plane arrangement in the case of an illumination of the specimen 1 by more than two mutually parallel light sheets LB1, LB2, LB3: To this end, a beam splitter 14 which divides the detection beam path into a plurality of partial beams has to be arranged in said detection beam path.

All arrangements according to the invention which were described here in the exemplary embodiments may be provided, additionally, with spectral filters or beam splitters in order to image different wavelengths onto different parts of the detector. In this case, the fluorescence of the individual light sheets may overlap.

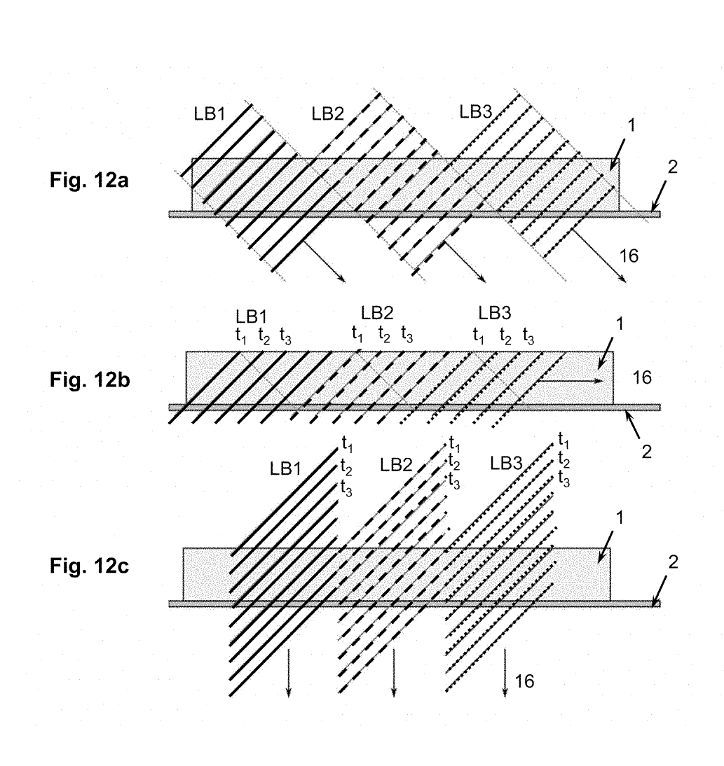

In order now to carry out a volume scan of a specimen 1 and hence, ultimately, be able to represent the whole specimen 1, FIGS. 12a, 12b and 12c illustrate different scanning regimes for a volume scan of a specimen 1 using an arrangement according to the invention for light microscopy.

In order to record the entire volume of the specimen 1, it is necessary to carry out a relative movement between the specimen 1 and the light sheets LB1, LB2, LB3 in order thus to record a z-stack for each light sheet LB1, LB2, LB3. These individual z-stacks are subsequently combined by calculation to form a 3D volume of the specimen 1. The relative movement can be carried out by virtue of the specimen 1 or the light sheets LB1, LB2, LB3 being displaced. Here, three scanning regimes are preferably conceivable: a relative movement parallel to the detection direction, as illustrated in FIG. 12a, a relative movement parallel to the object carrier 2, as illustrated in FIG. 12b, and a relative movement perpendicular to the object carrier 2, as illustrated in FIG. 12c.

Here, FIGS. 12a to 12c in each case show three light sheets LB1, LB2, LB3 that are arranged parallel to one another at different times t₁, t₂, t₃ etc. on their path through the specimen 1. Here, a scanning direction 16 in the detection direction of FIG. 12a or a scanning direction 16 parallel to the object carrier 2 of FIG. 12b is particularly advantageous since this allows the shortest possible light sheet length to be used. The movement parallel to the object carrier 2 of FIG. 12b offers the additional advantage of the energy influx into the specimen volume being the lowest and consequently of fading of the specimen 1 and a phototoxicity of the radiation on the specimen 1 being reduced.

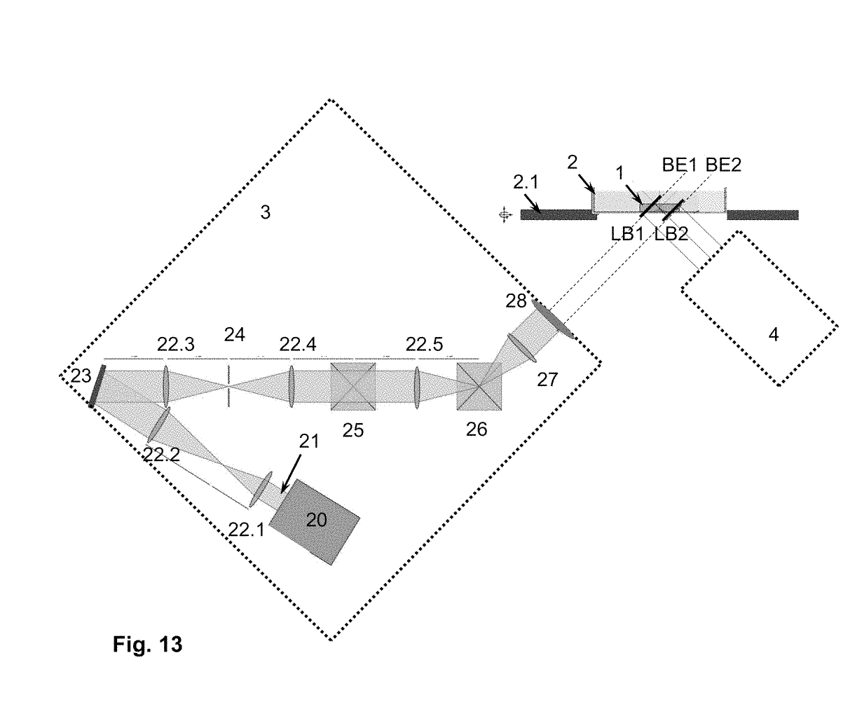

An exemplary embodiment of an apparatus for producing light sheets LB1, LB2 that are arranged parallel to one another and have mutually different focal planes in an illumination apparatus 3 for the purposes of an appropriate illumination of a specimen 1 with a plurality of light sheets LB1, LB2 that are arranged in parallel with one another for an arrangement and a method for light sheet microscopy is shown in FIG. 13.

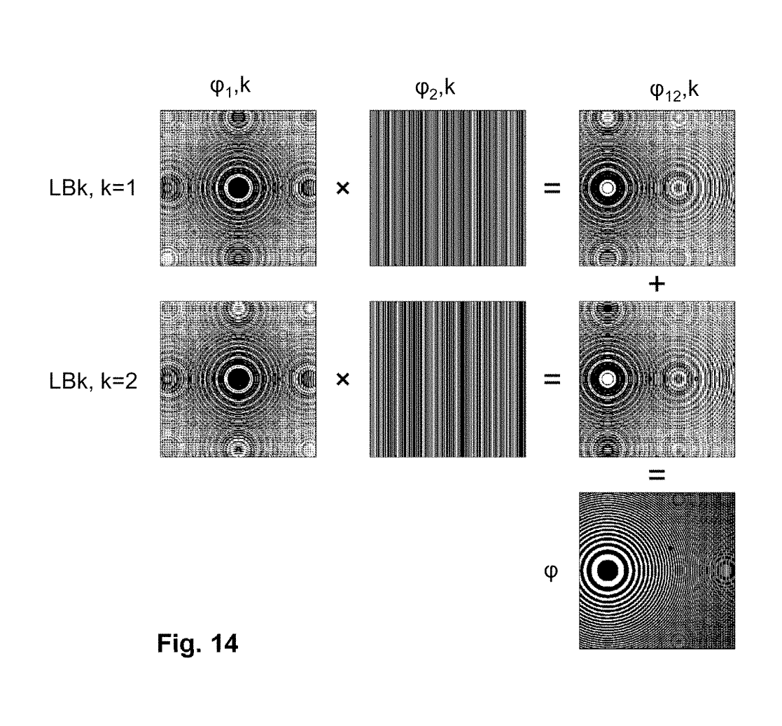

A laser module 20 produces a Gaussian laser beam 21. This laser beam 21 is widened by the lenses 22.1 and 22.2 in such a way that it uniformly illuminates the whole SLM 23 which is situated in spatial frequency domain, i.e. in the plane conjugate to the pupil. In this example, the spatial light modulator (SLM) 23 is a nematic SLM, i.e. a spatial light modulator which contains a liquid crystal phase, the liquid crystal molecules of which have a preferential direction. An appropriate phase pattern, the overall phase function φ, the production of which is illustrated in FIG. 14, is encoded onto the SLM 23. As a result, the spectrum of a plurality of parallel, focus-shifted light sheets LB1, LB2 is produced. The spectrum of the SLM plane is transferred into the spatial domain by means of the lens 22.3. Here, there may be filtering, for example by means of a stop 24. The stop plane is imaged onto a deflection mirror 26 by way of the lenses 22.4 and 22.5, said deflection mirror steering the plurality of light sheets that are arranged parallel to one another and that are encoded into the beam onto the specimen 1 via the imaging optical unit 27, 28, which is a combination of tube lens 27 and illumination objective 28, said specimen being situated on a transparent object carrier 2 in a specimen plane 2.1. Between the lenses 22.4 and 22.5, a scanner mirror pair 25 ensures the appropriate deflection in the x-direction and y-direction of the plurality of light sheets that are arranged parallel to one another and that are encoded into the beam.

In the two stripes of the specimen 1 that are illuminated by the light sheets LB1, LB2, fluorescence radiation is excited in each case, which fluorescence radiation can be detected sequentially in time with any detection apparatus used in light sheet microscopy or else can be detected simultaneously with a preferred detection apparatus 4 of an arrangement according to the invention for light sheet microscopy, wherein the detection apparatus 4 is only indicated in FIG. 13.

In FIG. 14, the construction of an SLM phase function φ or the composition thereof from the individual components, i.e. the fundamental phase functions, is illustrated using the example of the production of two parallel Gaussian light sheets which have different focal positions.

A defocus transfer function

$${T}_{1} ( r ) = exp ( \frac{π {ir}^{2}}{{f}_{1}} )$$

with the focal length f₁ of a virtual lens and r=\sqrt{x²+y²}, where x predetermines the x-coordinate of the SLM and y predetermines the y-coordinate of the SLM, and the coordinates of the spatial light modulator (SLM) describe the respective pixels, is designed in such a way that the respective focus lies in the desired plane BE1, BE2 of the light sheets LB1, LB2.

The light sheet LB1, LB2 is positioned in the specimen 1 with the aid of the transfer function of a blazed grating or of a wedge T₂(x,y)=exp(ixdₓ+iyd_{y}), with the position dx of the light sheet LB1, LB2 in the specimen 1 in x and the position dy of the light sheet LB1, LB2 in the specimen 1 in y. The combination, i.e. the combined transfer function, emerges from multiplying the individual transfer functions T₁₂=T₁·T₂. The combined transfer function T_{12,k} is calculated for all light sheets k=1, 2, 3, . . . , n. The overall phase function φ, which is ultimately transferred onto the spatial light modulator (SLM) 23 in FIG. 13, emerges from adding the individual combined transfer functions to form a complex overall transfer function T=Σₖ₌₁ⁿ T_{12,k} and from ascertaining the angle of this complex transfer function T with φ=angle(T).

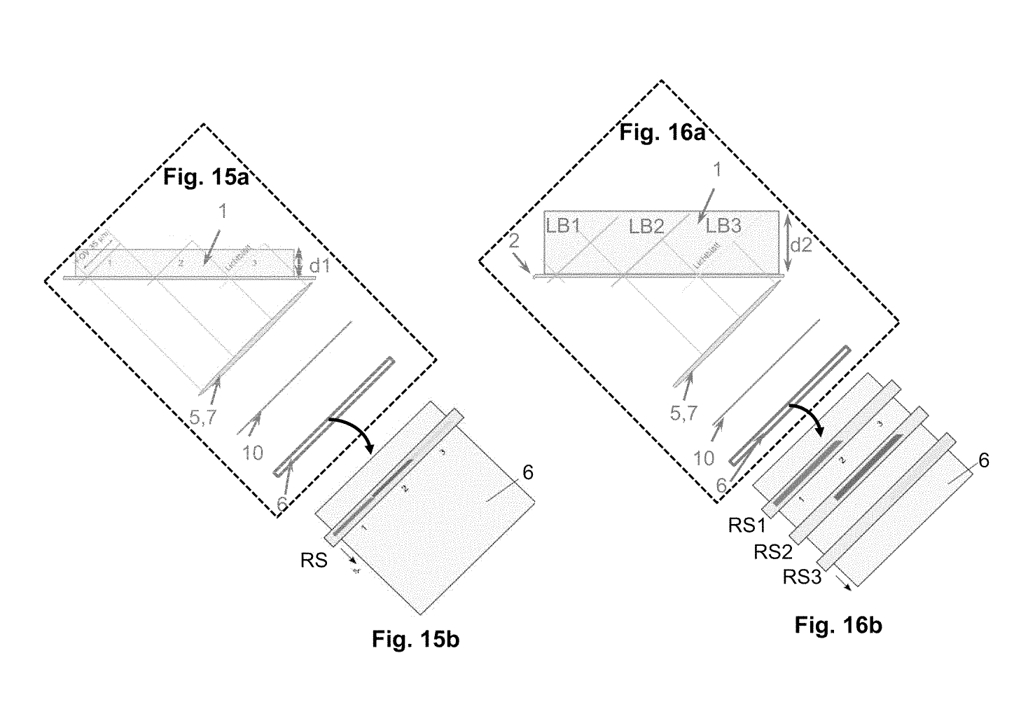

In order to be able to detect the fluorescence radiation from different stripes of mutually parallel light sheets LB1, LB2, LB3, which have the same wavelength, without interference from out-of-focus light from the stripes of adjacent light sheets LB1, LB2, LB3 despite overlaps in their projections in the detection action 9, FIG. 15a shows, in a plan view, an eighth exemplary embodiment of the arrangement according to the invention for light sheet microscopy having a sensor 6 which is configured for confocal detection. This representation of the arrangement of the optical elements among themselves, from the stripes of a specimen 1 on an object carrier 2 that are illuminated by the light sheets LB1, LB2, LB3 up to the sensor 6, which corresponds to the first exemplary embodiment in FIG. 4, is replaceable, in principle, by any of the arrangements of the second to seventh exemplary embodiment of FIGS. 6 to 11, but also by other embodiments not illustrated here. What is important in FIG. 15a is that this is a very thin specimen 1, the thickness d of which lies in a range between 10 μm and 30 μm, and optionally is even less than 10 μm. In the case of such a thin specimen 1, a confocal detection of the fluorescence radiation from a plurality of light sheets LB1, LB2, LB3 that are arranged parallel to one another and that are imaged next to one another on the sensor 6 is possible with a single rolling shutter RS if use is made of a CMOS camera as a sensor 6. This is illustrated in FIG. 15b, which shows a front view of the sensor 6 of the eighth exemplary embodiment. The fluorescence radiation that is produced in this thin specimen 1 by the light sheets LB1, LB2, LB3 that are arranged parallel to one another is detected next to one another in the “rolling shutter” RS in the process. Accordingly, the sensor 6 must be oriented relative to the light sheets LB1, LB2, LB3 as in FIG. 15b.

In the case of relatively long light sheets LB1, LB2, LB3 or thicker specimens 1, the light sheets LB1, LB2, LB3—or the fluorescence radiation thereof—possibly no longer “fit” next to one another within the rolling shutter RS. Then, the parallelization in the detection can be effectuated along the movement direction of the rolling shutter RS, and one rolling shutter RS1, RS2, RS3 can be generated for each light sheet LB1, LB2, LB3.

Thus, if the specimen 1 is substantially thicker than 20 or 30 μm, a confocal detection with a plurality of rolling shutters RS1, RS2, RS3 is necessary. Such a ninth exemplary embodiment of the arrangement according to the invention for light sheet microscopy having a sensor 6 that is configured for the confocal detection of relatively thick specimens 1 is illustrated in the plan view in FIG. 16a. This representation of the arrangement of the optical elements among themselves, from the stripes of a specimen 1 on an object carrier 2 that are illuminated by the light sheets LB1, LB2, LB3 up to the sensor 6, which corresponds to the first exemplary embodiment in FIG. 4, is replaceable, in principle, by any of the arrangements of the second to seventh exemplary embodiment of FIGS. 6 to 11, but also by other embodiments not illustrated here.

FIG. 16b now shows the detector 6 of the ninth exemplary embodiment in a frontal view: By way of a suitable actuation, a plurality of rolling shutters RS1, RS2, RS3 run with spatial offset over a CMOS sensor 6. Thus, the parallelization is effectuated along the other sensor coordinate. To this end, the means for adapting the imaging lengths such as gratings, microlenses, etc. must be rotated by 90 degrees according to their effect for the purposes of a congruent coverage of the focal plane of the respective light sheet LB1, LB2, LB3 with its detection plane. In this case, the sensor region that can be passed over without interference for each rolling shutter RS1, RS2, RS3 is restricted to the n-th part of the sensor dimension, with the number of rolling shutters or light sheets equaling n, which in turn leads to a restriction of the usable visual field in the light sheet scanning direction.

In addition to the exemplary embodiments shown in FIGS. 15/15a and 16/16a, further alternative solutions for a confocal detection of a plurality of mutually parallel light sheets also are possible: The commercially available sCMOS cameras use two sensor halves placed next to one another, which are read separately, for the purposes of accelerating the frame rate in the case of a large image field. This is conditional on the sCMOS cameras having two “rolling shutters”. If these run in the same direction, such a camera can be used directly for the parallelization proposed here, in this case by a factor of two.

However, in currently commercially available sCMOS camera systems, the two rolling shutters run in opposite directions. However, such a camera also can be used for a twofold parallelization of the detection by virtue of still introducing an optical inversion for one of the channels. Such an optical inversion can be effectuated by further imaging, e.g. by means of a microlens array, for one sensor half. An optical inversion is also possible by way of a mirror arrangement with an odd number of reflections. And not least, an optical inversion is possible using an inverting prism, such as e.g. a roof pentaprism which likewise has an odd number of reflections. This variant is particularly advantageous since a back focal length change is also introduced in addition to the inversion of the image by way of the passage of the radiation through a glass material and by way of the folding of the beam path through the prism, which back focal length change then also can be used immediately for the displacement of the focal plane, which is required for the parallelization, and can be designed accordingly.

However, the scanning direction of the second light sheet likewise could be inverted during the excitation in order to directly use such a camera with opposing rolling shutters. This can be effectuated by way of a pupil split, for the purposes of which a second illumination beam path and a second scanner are required.

A further exemplary embodiment of a confocal detection is the realization of a “digital slot aperture” with a very fast camera: A camera frame is recorded for each light sheet position and only the pixels which correspond to the respective light sheet position are evaluated. However, a camera image must be recorded and evaluated in this case for each light sheet position.

It is also possible to realize a descanning arrangement by way of a second scanner in the detection beam path. Here, the second scanner is synchronized with the light sheet scanner in such a way that the line remains stationary. As a consequence, use can be made of a line sensor or a fast area sensor with a digital slot aperture, as described above, or else a fast area sensor with an arrangement of a real confocal slot aperture in the beam path upstream of the area sensor.

As already mentioned, structured illumination is a further option for increasing the resolution and suppressing the background, i.e. the out-of-focus components of other light sheets, when detecting the fluorescence radiation of a light sheet.

The incoherent structuring of the illumination emanates from a scanned light sheet, i.e. from a light sheet that is spanned by the scanning process of a beam, such as e.g. a Gaussian beam, a Bessel beam or a similar non-diffraction-limited beam, wherein the scanning process is fast in relation to the camera exposure time. If the exposure by the laser is now interrupted at exactly defined times during this scanning process, for example by “blanking” which can be formed by acousto-optic modulators, then a grating can be “written into the specimen”. In the case of an illumination with three mutually parallel light sheets, the grating must then be displaced by ⅓ of the grating period in the two subsequent scans of the same specimen region, for example, in order to produce a corresponding phase shift. This is achieved by a temporal shift of the “blanking”. Subsequently, the three images are combined by calculation in order to eliminate the out-of-focus components.

For coherent structuring of the illumination, the grating or the structuring is produced by interference. Examples of such coherent structuring are described by Gustafsson in “Surpassing the lateral resolution limit by a factor of two using structured illumination microscopy”, J. Microsc., 2000, 198(2), 82-87, and, in the context of the light sheet microscopy, by Chen et al. in “Lattice light-sheet microscopy: Imaging molecules to embryos at high spatiotemporal resolution”, Science, 2014, 346, 6208: 1257998 or in WO 2014/005682 A2.

For the parallelization of the light sheet microscopy for relatively thick specimens, treated here, both variants of the structuring can be used for suppressing unwanted background fluorescence, in particular the background fluorescence in the respective other light sheets. Here, in turn, the following modes of operation are possible for a synchronous illumination of a specimen with a plurality of mutually parallel light sheets:

Incoherent structuring of the illumination can be effectuated in monochrome fashion by n light sheets with the same wavelength. The structuring is realized by “blanking”, i.e. interruptions of the scanning process, which are produced by an AOTF, “acousto-optic tunable filter”, i.e. an acousto-optic modulator. A phase shift is effectuated by a temporal displacement of the “blanking” during the light sheet scan.

Incoherent structuring of the illumination can be effectuated in polychrome fashion by n light sheets with n wavelengths, which are detected on n sensor regions. The structuring is realized by simultaneous “blanking” by means of an AOTF for the n wavelengths. A phase shift is effectuated by a temporal displacement of the “blanking” during the light sheet scan.

An illumination with coherent structuring of the light sheets can be effectuated in monochrome fashion by n light sheets with the same wavelength. In the case of some advantageous beam forms, such as e.g. a sinc³ beam or a Mathieu beam or a coherent superposition of Bessel beams, the structuring can be intrinsically present by suitable selection of the phase pattern on the SLM. A phase shift is effectuated by displacing the structured light sheet by means of a scanner.

An illumination with coherent structuring of the light sheets can be effectuated in polychrome fashion by n light sheets with n wavelengths. In the case of some advantageous beam forms, such as e.g. a sinc³ beam or a Mathieu beam or a coherent superposition of Bessel beams, the structuring can be intrinsically present by suitable selection of the phase pattern on the SLM. In the case of n light sheets with n colors, the phase pattern on the SLM should be set in parallelized fashion for the light sheets of different color. A phase shift is effectuated by displacing the structured light sheets by means of a scanner. Here, it should be noted that the structuring for the light sheets of different wavelengths should be chosen to be the same if the phase shift for all light sheets is effectuated by way of a common scanner.

In this case, the aforementioned features of the invention, which are explained in various exemplary embodiments, can be used not only in the combinations specified in an exemplary manner but also in other combinations or on their own, without departing from the scope of the present invention.

Moreover, the arrangements according to the invention for light sheet microscopy also are able to illuminate a specimen 1 with more than three light sheets that are arranged parallel to one another: An explanation of the application examples using two or three light sheets LB1, LB2, LB3 that are arranged parallel to one another is effectuated here for reasons of an improved understanding.

A description that relates to apparatus features applies analogously to the corresponding method in respect of these features, while method features represent corresponding functional features of the described apparatus.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1: An arrangement for light sheet microscopy, comprising:
a specimen plane for arranging a specimen;
an illumination apparatus comprising:
a light source; and
an illumination optical unit;
the illumination apparatus being configured to produce a first light sheet, which extends in non-parallel fashion in relation to the specimen plane, for illuminating a first stripe of the specimen and for exciting fluorescence radiation in this first stripe of the specimen; and
a detection apparatus comprising:
a sensor configured to detect the fluorescence radiation;
an imaging optical unit configured to image the fluorescence radiation from the first stripe of the specimen into a detection plane of the sensor; and
a detection axis that forms an angle with the first light sheet from an angle range of 700 to 110°;
wherein the illumination apparatus is configured to produce at least one further light sheet that is arranged parallel to the first light sheet but displaced in relation to the first light sheet in a detection direction along the detection axis and in an illumination direction, for illuminating a further stripe of the specimen and for exciting fluorescence radiation in this further stripe of the specimen; and
wherein the detection apparatus is configured to simultaneously detect the fluorescence radiation excited in the first stripe of the specimen by the first light sheet and the fluorescence radiation excited in the further stripe of the specimen by the further light sheet.

2: The arrangement for light sheet microscopy as claimed in claim 1;
wherein the detection apparatus further comprises:
a first detection plane that is assigned to the first light sheet; and
a further detection plane that is assigned to the further light sheet;
the detection apparatus being configured for simultaneous congruent coverage of a first focal plane of the first light sheet with the first detection plane and of a further focal plane of the further light sheet with a further detection plane.

3: The arrangement for light sheet microscopy as claimed in claim 1:
wherein the fluorescence radiation excited by the first light sheet and the fluorescence radiation excited by the further light sheet arranged in parallel are not superposed on one another in the detection direction; and
wherein a separate sensor position of the sensor is assigned in each case to the first light sheet and the further light sheet.

4: The arrangement for light sheet microscopy as claimed in claim 1:
wherein the detection apparatus further comprises at least one component selected from the group consisting of:
a means for spectral detection and/or;
a means for confocal filtering; and
a means for structured illumination.

5: The arrangement for light sheet microscopy as claimed in claim 1:
wherein the detection apparatus further comprises a phase element in a detection beam path.

6: The arrangement for light sheet microscopy as claimed in claim 5;
wherein the imaging optical unit comprises:
an objective; and
a phase grating that is arranged between the objective and the sensor.

7: The arrangement for light sheet microscopy as claimed in claim 5, further comprising:
a spatial light modulator with a phase function in a spatial frequency domain or in a spatial domain.

8: The arrangement for light sheet microscopy as claimed in claim 1:
wherein the sensor of the detection apparatus is configured so that a first sensor region is assigned to the first light sheet and a further sensor region is assigned to the further light sheet, said further sensor region being arranged relative to the first sensor region in a manner displaced along the detection axis.

9: The arrangement for light sheet microscopy as claimed in claim 1:
wherein the detection apparatus further comprises a fiber plate comprising:
glass fibers having:
first ends of the glass fibers are arranged for input coupling of the imaged fluorescence radiation; and
opposite ends of the glass fibers are in direct contact with the sensor or are imageable on the sensor by optical means;
a first fiber plate portion assigned to the first light sheet; and
a further fiber plate portion assigned to the further light sheet;
wherein the first ends of the glass fibers of said further fiber plate portion are arranged so as to be displaced along the detection axis.

10: The arrangement for light sheet microscopy as claimed in claim 1:
wherein the detection apparatus further comprises:
a microlens array arranged between an objective of the imaging optical unit and the sensor, the microlens array comprising:
a first microlens of a first type with a first refractive power, which is assigned to the first light sheet; and
a further microlens of a further type with a further refractive power, which is assigned to the further light sheet;
wherein the first refractive power of the first microlens is dependent on a spatial orientation of first focal plane and the further refractive power of the further microlens is dependent on a spatial orientation of a further focal plane.

11: The arrangement for light sheet microscopy as claimed in claim 4;
wherein the detection apparatus further comprises:
a beam splitter in a detection beam path, said beam splitter being arranged in such a way that it divides the detection beam path, and a first focal plane assigned to the first light sheet and a further focal plane assigned to a further light sheet are imaged next to one another on the sensor.

12: The arrangement for the light sheet microscopy as claimed in claim 1:
wherein the arrangement is configured to carry out a volume scan of the specimen.

13: The arrangement for light sheet microscopy as claimed in claim 12, further comprising:
a means for carrying out a relative movement between the light sheets and the specimen along an axis parallel to the specimen plane, to an object carrier, or to both.

14: The arrangement for light sheet microscopy as claimed in claim 12, further comprising:
a means for carrying out a relative movement between the light sheets and the specimen along an axis parallel to the detection direction.

15: The arrangement for light sheet microscopy as claimed in claim 12, further comprising:
a means for carrying out a relative movement between the light sheets and the specimen along an axis perpendicular to the specimen plane, to an object carrier, or to both.

16: The arrangement for the light sheet microscopy as claimed in claim 1:
wherein the first light sheet and the further light sheet are based on Gaussian beams or Bessel beams or Mathieu beams or sinc³ beams.

17: The arrangement for light sheet microscopy as claimed in claim 1:
wherein a length of the first light sheet, of the further light sheet, or of both is matched to a thickness of the specimen.

18: A method for light sheet microscopy comprising:
illuminating a specimen by at least two light sheets that are arranged in parallel to one another and perpendicular to a detection axis, but which are displaced in relation to one another in a detection direction along the detection axis and in the illumination direction;
utilizing the at least two light sheets to produce fluorescence radiation in the respective stripes in the specimen;
imaging said fluorescence radiation by an imaging optical unit in a focal plane; and
detecting the imaged fluorescence radiation by a sensor;
wherein a focal plane of each of the at least two light sheet is brought in correspondence with a detection plane of the respective light sheet for detecting the fluorescence radiation of the respective stripe of the specimen;
wherein the fluorescence radiation excited in the respective stripes of the specimen is detected simultaneously.

19: A method for light sheet microscopy comprising:
utilizing the arrangement for light sheet microscopy as claimed in claim 1 to perform steps comprising:
illuminating a specimen by at least two light sheets that are arranged in parallel to one another and perpendicular to a detection axis, but which are displaced in relation to one another in a detection direction along the detection axis and in the illumination direction;
utilizing the at least two light sheets to produce fluorescence radiation in the respective stripes in the specimen;
imaging said fluorescence radiation by an imaging optical unit in a focal plane; and
detecting the imaged fluorescence radiation by a sensor;
wherein a focal plane of each of the at least two light sheet is brought in correspondence with a detection plane of the respective light sheet for detecting the fluorescence radiation of the respective stripe of the specimen;
wherein the fluorescence radiation excited in the respective stripes of the specimen is detected simultaneously.
